(19) United States
(12) Patent Application Publication
(10) Pub. No.: US 2018/0253091 A1
(43) Pub. Date: Sep. 6, 2018

(54) CONTROL AND REMOTE CONTROL FOR AN UNMANNED FLYING OBJECT, AND METHOD FOR CONTROLLING THE FLYING OBJECT

(71) Applicant: Antony PFOERTZSCH, Bremen (DE)

(72) Inventor: Antony PFOERTZSCH, Bremen (DE)

(21) Appl. No.: 15/973,029

(22) Filed: May 7, 2018

Related U.S. Application Data
(63) Continuation of application No. PCT/EP2016/076440, filed on Nov. 2, 2016.

(30) Foreign Application Priority Data
Nov. 9, 2015 (DE) 10 2015 119 279.9

(51) Int. Cl. G05D 1/00

(52) U.S. Cl. CPC G05D 1/0016; B64C 39/024

(57) ABSTRACT

The present disclosure relates to a control for an unmanned flying object and to a method for controlling an unmanned flying object, in particular for a drone or a multicopter. The control includes an assistance circuit. The control is configured to receive control commands to control the flying object, for example, via a radio interface, to modify the received control commands with the assistance circuit depending on a configuration of the assistance circuit, and to transmit the modified control commands. The assistance circuit has an interface and the configuration of the assistance circuit is reconfigurable with the interface. The present disclosure furthermore relates to a remote control to control the unmanned flying object with the control.

### BACKGROUND

### Technical Field

The present disclosure relates to unmanned flying objects which are, in particular, drones or copters, for example quadcopters or multicopters.

### Description of the Related Art

Today, unmanned flying objects of this type are used in the widest variety of fields, for example to make photo and video recordings from the air. Unmanned flying objects are accordingly known which have a support on the underside, in particular a gimbal, to which a photo or video camera is attachable.

Unmanned flying objects are frequently used in the film industry in order to be able to dispense with camera cranes or other complex constructions to guide the camera in the case of complex film scenes for which, for example, an ascent of a building facade or the tracking of a vehicle is to be recorded.

However, flying maneuvers to perform the aforementioned complex scenes are often carried out by highly experienced pilots, since it is desirable for the control of flying maneuvers of this type to be carried out by someone with a precise knowledge of the flying object and its behavior in flight.

Assistance systems are known which are integrated into the unmanned flying objects and which support an operator during the operation and control. Nevertheless, despite these assistance systems, a precise knowledge of the flying behavior is still desirable since the weight of the flying object, e.g., following a change of lens in the case of a camera connected to the unmanned flying object, can change and impact the flying behavior, such that a pilot should take account of the changed flying behavior.

Furthermore, different patterns of interaction with the environment and with obstacles should be used depending on visibility conditions, such as e.g., wind and rain, and/or preferences of a pilot or user.

### BRIEF SUMMARY

On the basis of the prior art, it is desirable to develop an unmanned flying object and to find a method for its control so that even inexperienced pilots can control an unmanned flying object in essentially any situation, wherein the risk of destruction of or damage to the unmanned flying object is to be reduced as far as possible.

To do this, a control and a method of control for an unmanned flying object are proposed which are suitable, for example, for a drone or a copter, such as e.g., a quadcopter or octocopter. In one embodiment, the control is configured to receive control commands to control the flying object, modify the received control commands with an assistance circuit depending on a configuration of the assistance circuit, and transmit the modified control commands. The configuration of the assistance circuit is reconfigurable through, for example, a remote control.

### BRIEF DESCRIPTION OF THE SEVERAL VIEWS OF THE DRAWINGS

Further advantageous example embodiments of the present disclosure are explained in detail below with reference to the drawings.

FIG. 1 shows an unmanned flying object according to an embodiment of the present disclosure.

FIG. 2 shows a control for an unmanned flying object as a block diagram according to an embodiment of the present disclosure.

FIG. 3 shows a remote control according to an embodiment of the present disclosure.

FIG. 4 shows a method for controlling an unmanned flying object according to an embodiment of the present disclosure.

FIG. 5 shows the learning of a configuration module by means of a test flight according to an embodiment of the present disclosure.

FIG. 6 shows a representation on the screen of the remote control according to an embodiment of the present disclosure.

FIG. 7 shows an additional or alternative representation on the screen according to an embodiment of the present disclosure.

### DETAILED DESCRIPTION

The present disclosure is directed to a control for an unmanned flying object and to a method for controlling the unmanned flying object.

In one embodiment, the control is configured to receive control commands to control the flying object, for example, via a radio interface. The control furthermore has an assistance circuit and is configured to modify the received control commands with the assistance circuit depending on the configuration of the assistance circuit. The control device is furthermore configured to transmit the corrected control commands.

In one embodiment, the assistance circuit has an interface, which can also be referred to as a reconfiguration interface, via which the configuration of the assistance circuit is reconfigurable.

The control according to one or more embodiments is accordingly e.g. a component part of the flying object and is configured to receive control commands from a user, who may also be referred to as a pilot or operator. For this purpose, the control commands are transmitted, for example, by the user via a radio remote control, are received via a radio interface of the control and are fed to the control.

In one embodiment, the received control commands are then fed to the assistance circuit which modifies, i.e., corrects, manipulates or the like, the control commands depending on their configuration. The control commands are modified accordingly in the assistance circuit as specified by the configuration of the assistance circuit.

In one example, the user specifies the control command that the flying object is to stop, e.g., in front of an obstacle, after flying straight ahead, e.g., by changing the position of a joystick from a forward-pointing position into a neutral position. Depending on the configuration of the assistance circuit, a reverse flying command is then additionally generated along with the forward flying command and the ending of the forward flying for a short time duration and intensity. As a result, the flying object is essentially momentarily stopped, despite its forward-directed momentum, as specified by the user. The duration and intensity of the reverse flying command are defined by the assistance circuit depending on the configuration.

According to one embodiment, the assistance circuit is equipped with a reconfiguration interface via which new configurations for the assistance circuit are specifiable by a user so that a hitherto existing configuration can be replaced with a current configuration.

Different configurations are provided accordingly, e.g., for different cameras or lenses which are carried with the flying object with the control and which differ in weight, wherein these different configurations are specifiable in each case by a user for the assistance circuit.

To complement the aforementioned example of stopping after flying straight ahead, the time duration, for example, and/or the intensity for the reverse flying is/are also changed for faster stopping by changing the configuration. If, for example, a heavier lens is used, the forward-directed momentum of the flying object is greater after flying straight ahead than in the case of a lighter lens. The time duration and/or intensity for the opposite control command, e.g., the reverse flying, should therefore be longer in the case of a heavier lens than in the case of a lighter lens. This adaptation of the different time durations and/or intensities to different lenses is now carried out by simply changing the current configuration of the assistance circuit.

A user who exchanges, for example, a light lens for a heavy lens advantageously simply has to ensure that the assistance circuit makes use of the configuration which corresponds to the configuration for the current lens following the change of lens. An identical flying behavior of the flying object can be achieved despite different cameras or lenses by adapting the configuration of the assistance circuit so that the operation of the flying object is significantly simplified for a user.

According to one embodiment, each configuration of the assistance system consists of a group, i.e., a plurality of configuration modules which can be assigned, in particular, to different categories. A first category relates, for example, to the behavior on take-off or landing, and a further category relates to the stopping in front of or behavior in relation to obstacles. Categories are furthermore conceivable which include the performance of predefined flying maneuvers in relation to detected objects or obstacles, i.e., for example, the entire surroundings or environment around the flying object.

According to this embodiment, the control furthermore includes a memory in which a plurality of different configuration modules for the configuration of the assistance circuit is storable in the memory. Alternatively or additionally, the control furthermore includes a connection for a computer and/or a reading device for storage media in order to receive further configuration modules from an external data source.

In one embodiment, configuration modules for the configuration of the assistance circuit are stored accordingly in a memory. The configuration modules can be used accordingly by the assistance circuit directly from the memory or can be loaded into the assistance circuit for the use. Additionally or alternatively, a reading device for storage media, e.g., for SD cards, is present with which further configuration modules, e.g., not stored in the memory, can be received from an external data source or from a computer. These configuration modules provided from a memory card or a computer are furthermore storable in the memory so that they are available for the subsequent use even without a computer.

It is conceivable, for example, that configuration modules for a camera or lens which is to be used with the unmanned flying object are made available on a storage medium or via the Internet. The corresponding configuration module can thus be made available in a simple manner for the assistance circuit when the corresponding camera or lens according to the last-mentioned embodiment is used.

According to a further embodiment, the control has selection means for selecting one or more configuration modules which are loaded from the memory, the reading device or a computer into the assistance circuit or are made available to the assistance circuit. The current configuration of the assistance circuit, i.e., the configuration which the assistance circuit uses until the next selection of different configuration modules is thus specified or defined with the selection means.

The selection means thus enable a user to exchange the configuration modules, i.e., to reconfigure, i.e., to modify or adapt, the configuration in a simple manner during the use of the unmanned flying object.

According to a further embodiment, the memory includes a non-overwritable or non-erasable memory area or memory module protectable by access rights or by a hardware implementation for non-erasable configuration modules which are, for example, specified by a manufacturer. A part of the memory or a memory module of the memory is therefore provided accordingly which is protectable with access rights or is implemented as a non-overwritable and non-erasable memory in which non-erasable configuration modules are restricted to be storable by a manufacturer or by service personnel. The user therefore merely has read access rights to these memory areas or this memory module and the configuration modules contained therein.

Additionally or alternatively, a memory area or a dedicated memory module is provided in the memory in which further configuration modules are storable and are also erasable or overwritable once more by the user. Configuration modules which, for example, are generated by a user himself or are transferred via a memory card or a computer are storable in this memory area in the rewritable memory area or in the rewritable memory module.

Due to the protectable or non-erasable memory area, it is possible to store configuration modules in this memory area which enable a fundamental correction of flying commands regardless of the equipment or the flying maneuver. These configuration modules are thus, for example, specified by a manufacturer and are protected against accidental erasure by a user, so that at least one basic functionality of the assistance circuit is retained during the operation of the flying object also. The rewritable memory area furthermore serves to store user-specific configuration modules for the user.

According to a further embodiment, the control includes a sensor interface to connect at least one sensor of an unmanned flying object to the control. The assistance circuit is furthermore configured to take account of sensor data received from the sensor interface when modifying the received control commands depending on the current configuration.

In one embodiment, the sensor interface is configured to be connected to radar sensors, image-recording sensors such as cameras, in particular a stereoscopic camera, a laser scanner or a lidar sensor, such as a solid-state lidar sensor.

In one embodiment, distance-measuring sensors, for example, such as radar sensors or a stereoscopic camera are provided accordingly in the flying object and operate, for example, according to the transit time principle and are, for example, radar sensors or sound sensors and serve to measure the distance between the unmanned flying object and an obstacle, such as e.g., a wall or tree. The sensor signals of the sensors are received by the control and can be taken into account differently during the modification of the control commands in the assistance circuit depending on different configurations.

If, for example, a film recording is to be made with the unmanned flying object and a camera attached to it such that the flying object approaches an obstacle at maximum speed and stops at a distance of a few meters or centimeters in front of the obstacle, a timely stopping of the flying object is desirable for this purpose in order to avoid a collision with the obstacle. Determining the right time to find the distance and/or a dynamic braking curve for stopping is often performed by a professional user or operator.

A braking curve is, for example, any dynamic braking process in which the braking force, i.e., a negative acceleration, is increased or reduced gradually or continuously.

In a further example, the user would like to have the drone fly inside a tunnel after an automobile. Here, the drone should keep to the right-hand lane at a fixed distance from the tunnel wall so as not to endanger oncoming traffic. At the same time, the drone should maintain a fixed distance from the automobile and be able at all times to brake in an emergency before colliding with the automobile.

This scenario, which in any case is often flown by experienced pilots, is additionally hindered by the failure of the GPS inside the tunnel. In one embodiment, at least two configuration modules are used here in a profile, i.e., are configured as a configuration, in order to perform the maneuver. The first configuration module corresponds, for example, to a control loop which maintains a fixed distance from the right-hand tunnel wall orthogonal to the direction of flight, and the second configuration module corresponds, for example, to a control loop with which a minimum distance from the vehicle driving in front is maintained. The user can optionally increase the required distance via a control command or reduce it to the minimum distance.

According to the embodiment, however, a configuration module can be made available through selection by the user for the assistance circuit or can be loaded into the latter. The configuration module generates braking commands adapted according to the desired recording, taking account of the desired speed and the desired distance from the obstacle, and taking account of the weight of the selected camera.

Following the loading or provision, a user of the unmanned flying object can be confident that the assistance circuit will convert the received control commands into stopping commands or braking commands or will modify them when the desired distance from the obstacle is reached, even if the user, as specified by a control command from the user, continues to steer toward the obstacle at full speed. Difficult flying maneuvers are thus possible even with little or even without flying experience.

In a further example, the user gives the control command to fly straight ahead, but does not notice an obstacle. Depending on the configuration of the assistance circuit, a braking stored by the user with a configuration module for situations of this type is then carried out despite the command to fly straight ahead, so that the flying object stops at a distance similarly defined by the or a further configuration module. A dynamic braking according to a braking ramp, for example, is possible here.

Via the current configuration of the assistance circuit, the user accordingly has the facility, for example, to specify the measured distance or the angle of view, defined with a sensor connected via the sensor interface, from which or at which the assistance circuit intervenes in the control commands of the user. The type of intervention, i.e., the type of a braking curve or a maximum speed in the approach to an obstacle is furthermore specifiable.

The user is additionally enabled to fly along or inside structures, such as, for example, tunnels, forests or buildings, without running the risk of a collision. Since the structures all have different dimensions, such as heights, widths, lengths or shapes, the user can generate a suitable configuration module automatically by means of a slow test flight with the drone and through the measurement with the connected sensors. In one embodiment, the configuration module includes a beamforming, pressure angle and the minimum distances between the drone and all existing objects in relation to the flight alignment or sensor alignment.

Sensor data are therefore receivable through the sensor interface, and the control command of the user is converted in the assistance circuit depending on the sensor data and configuration.

In the case of the unnoticed obstacle, depending on the configuration of the assistance circuit, the obstacle is flown around, for example, despite the command from the user to fly straight ahead, or a switch to a reverse flight is performed in front of the obstacle so that the flying object begins to initiate a controlled braking.

It is accordingly also possible, for example, to recognize patterns or objects with a camera connected via the sensor interface and to adapt the flying behavior with the assistance circuit according to these recognized patterns or objects. The flight paths can be oriented according to recognized patterns or objects depending on the configuration toward; and, for example, even in the case where the patterns or objects move, to not understep a specified distance, even if a command is given which would result in an understepping of the distance without the assistance circuit.

According to a further embodiment, the control includes at least one control output for transmitting control commands to at least one actuator of a flying object or its drive. Here, an actuator is e.g., a motor or its drive for a propeller of the flying object. The modified control commands thus correspond directly to the drive signals or serve to define drive signals in order to generate rotational speed specifications for the rotational speed of a propeller of the flying object.

According to a further embodiment, the control includes automatic selection means to automatically select correction modules stored in the memory depending on sensor data which are obtained from a further sensor interface from a further sensor. The correction modules are used as the current configuration or are loaded into the assistance circuit as the current configuration.

The automatic selection means are connected accordingly e.g., to a sensor which can measure the weight attached to a mount of the unmanned flying object and can select configuration modules suitable for the weight depending on this weight. Accordingly, a current configuration which allows a precise flight control of the unmanned flying object can therefore also be selected automatically without intervention on the part of a user.

The present disclosure furthermore relates to a remote control for controlling an unmanned flying object with a control according to one of the aforementioned embodiments. The remote control is configured to transmit selection commands to the selection means of the control for selecting configuration modules for the configuration of the assistance circuit and/or to generate configuration modules and transmit the generated configuration modules to the control.

The remote control serves accordingly not only for the normal flight control of an unmanned flying object through the transmission of control commands, but also for the transmission of selection commands to the control of the flying object for the selection of configuration modules for the assistance circuit. The remote control therefore also serves to enable a remote reconfiguration of the assistance circuit and therefore to adapt the configuration of the assistance circuit for different flying maneuvers.

It is e.g., conceivable for a first configuration module to provide that the flying object stops at a distance of a few centimeters in front of an object. If a film scene in which this distance is desired is ended and a different scene is started in which a different behavior of the unmanned flying object is desired, the current configuration of the assistance circuit can be remotely modified by means of the remote control without the unmanned flying object having to land and be connected to a computer. A remote reconfiguration of the assistance circuit is therefore possible during the operation or flight operation.

According to a further embodiment, the remote control includes input means and a screen, wherein the screen may be e.g., a Smartphone connected via a data connection, a tablet PC or the like. In the case of a screen configured as a Smartphone or tablet PC, the input means also comprise the touch-sensitive screen of the Smartphone or of the tablet PC. A plurality of combinations of different configuration modules which are presentable with the screen e.g., as groups, and/or individual configuration modules are also selectable with the input means.

The screen serves e.g., to present further information depending on the loaded configurations, such as e.g., currently recorded distance values of distance sensors or image processing information. Data are advantageously transmitted from the control to the remote control and are processed by the latter for display on the screen.

The remote control accordingly offers, for example, configuration modules of different categories sorted by groups for different desired flight situations. Configuration modules are selected accordingly, for example by selecting a group which is presented on the screen e.g., as a hotkey or fast selection key.

A fast change of the configuration of the assistance circuit with a plurality of configuration modules is thus possible in a simple manner through an input with the input means.

According to a further embodiment, configuration modules can be generated with the user interface and/or with the screen of the remote control by converting flight paths which, for example, are related to obstacles and are actually flown with the input means of the remote control and are simultaneously recorded, or are predefined graphically on the screen by a user, in the remote control with a computing logic into one or more configuration modules. These configuration modules can then be transmitted to the control of an unmanned flying object and/or can be stored in the remote control.

Accordingly, for example, in the case of a test flight oriented toward an obstacle, the control commands of the user carrying out the test flight and the sensor data which represent an orientation in relation to the obstacle are recorded and converted into a configuration module. The same flight path can thus subsequently be flown automatically by the assistance system in the event of the occurrence of an obstacle which is detected with a sensor, even if different flight commands are given by the user or operator.

Thus, in the case where the stored configuration modules are not suitable for an unexpected situation, new configuration modules which are adapted to the unexpected situation can also be generated during the use of the unmanned flying object with the remote control.

The present disclosure furthermore relates to a method for controlling an unmanned flying object, in particular with a control according to one of the preceding embodiments. In one embodiment, flight commands to control the flying object are received with the control and the received control commands are modified with an assistance circuit of the control depending on a configuration of the assistance circuit. The modified control commands are transmitted from the control to an actuator. In one embodiment, the configuration of the assistance circuit is configured or reconfigured by a user or automatically.

According to one embodiment of the method, sensor data from a sensor, e.g., a distance sensor, in particular for measuring the distance according to the transit time principle, or from a stereoscopic camera are received with a sensor interface of the control and the sensor data are taken into account in the modification of the received control commands depending on the current configuration.

According to one embodiment of the method, control commands for controlling the flying object from the remote control are transmitted with a remote control, in particular according to one of the aforementioned embodiments, for example in a learning mode of the remote control. The control commands are recorded in the remote control or the control of the unmanned flying object and the recorded commands are converted in the remote control or the control into one or more configuration modules and are stored in the memory of the control or remote control. Alternatively or additionally, sensor data of the sensors of the flying object resulting here from the control commands are recorded in the remote control or the control of the unmanned flying object and are also taken into account in the conversion of the commands.

It is thus possible, for example, for the user to have the drone hover in front of a scene and for objects to be marked for a respective configuration module. If, for example, the drone hovers in front of a tunnel entrance, the user marks this entrance and depth sensors measure the entrance. Finally, the user defines the behavior in a menu, for example evasive action, entry flight, color highlighting, and also an angle of view of the sensor in relation to the object and the reference system (relative to the drone or relative to the direction of flight).

The drone can then highlight the tunnel entrance on the screen by means of a hotkey and the user flies in one direction automatically into the tunnel entrance through the control of the drone. In the tunnel itself, the assistance system would then take over a configuration module of the configuration for the tunnel from the current profile, i.e., the current configuration. The generated configuration modules can serve later to configure the assistance circuit.

Configuration modules are generated accordingly by a user through a simple test flight and can then be reused as frequently as required. An experienced pilot, for example, can perform specific maneuvers in a test flight which can then, as it were, be reflown by a layman using the configuration modules generated by the test flight to configure the assistance circuit.

According to a further embodiment, one or more configuration modules stored in the remote control are selected with the remote control with input means of the remote control and the selected configuration modules are transmitted to the control. The configuration modules received by the control are stored in a memory or are loaded into the assistance circuit as the current configuration. Accordingly, it is also possible to transfer configuration modules stored in the remote control to the control with the remote control, said configuration modules then being able to be used for the further use in the control which is disposed in the flying object.

According to a further embodiment, fast selection keys, i.e., hotkeys, are made available with the input means and/or the screen and a group of configuration modules, i.e., a plurality of configuration modules, for example of different categories, are selected by selecting one of the fast selection keys. The selected group of configuration modules is then used as the current configuration of the assistance circuit or is loaded into the assistance circuit as the current configuration by transmitting a selection command to the control and by processing the selection commands with the selection means.

According to a further embodiment of the method, configuration modules last selected with the remote control and the last current configuration of the assistance circuit by the configuration modules are compared following a system start of the control. A fault signal is transmitted by the remote control or the system as soon as the compared configurations modules do not match one another.

Alternatively or additionally, the current configuration of the assistance circuit defined by the configuration modules is automatically checked for conflicting characteristics and a fault signal is similarly transmitted in the event of existing conflicting characteristics.

This involves not only a memory check in the conventional sense, but also the detection of possible errors in reasoning on the part of the pilot. For example, if a drone has two configuration modules with two targets, one configuration module intended to maintain a distance from a wall and another configuration module intended to maintain a distance from a driving automobile, the configuration modules come into conflict with one another as soon as the automobile is no longer driving parallel to the wall. The user would be instructed here to assign a higher priority to one of the configuration modules in order to leave the configuration module with the highest priority activated in the event of conflicts.

The present disclosure furthermore relates to a flying object with a control according to one of the aforementioned embodiments, and also a system with a flying object and a remote control according to one of the aforementioned embodiments, in particular for carrying out the method according to one of the aforementioned embodiments.

The present disclosure furthermore relates to a system with a control according to one of the aforementioned embodiments, and also with a remote control according to one of the aforementioned embodiments.

FIG. 1 shows an unmanned flying object 10 according to an embodiment of the present disclosure. The flying object 10 includes a control 12 and a plurality of actuators 14 to which a propeller 16 is in each case connected. A camera support 18, which is also referred to as a gimbal, is disposed on the underside of the unmanned flying object 10 which corresponds here to a quadcopter. A video camera 20 is attached to the lower end of the camera support 18.

The unmanned flying object 10 furthermore has an antenna 22 with which it can receive control commands to control the flying object 10. Control commands are therefore generated by a user with a remote control and are transmitted via a radio link to the antenna 22. The control commands are fed to the control 12 and are used with the control to drive the actuators 14. Control commands for the unmanned flying object 10 are e.g., raising, lowering, forward flying, reverse flying and/or sideways flying. These control commands are converted with a motor control into drive signals, and the drive signals serve to drive the actuators 14.

The control commands are converted accordingly into signals which, for example, cause the propellers 16 to rotate by means of the actuators 14, in each case at a specific rotational speed.

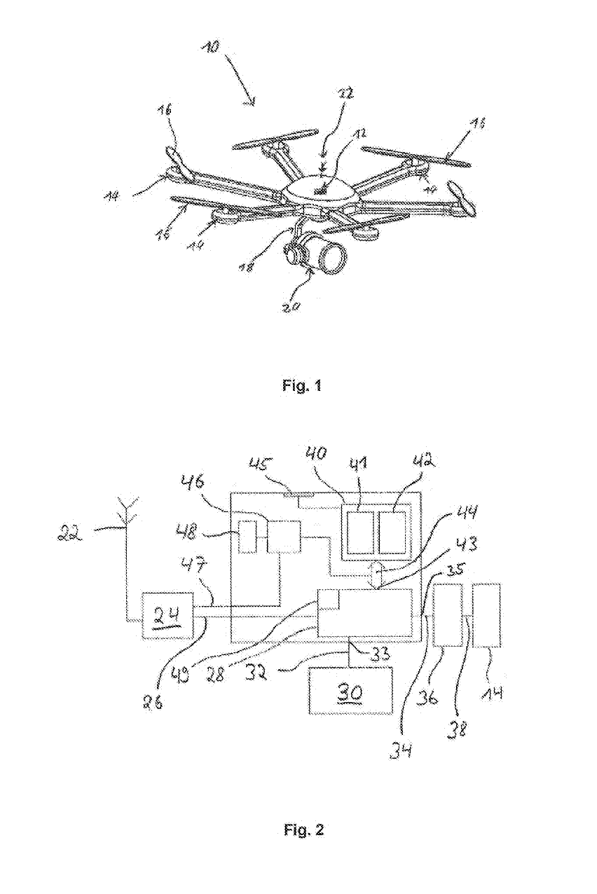

If, for example, the control command to raise the unmanned flying object 10 is received by the control 12, the control command is converted with the motor control into drive signals which result in an increase in the rotational speed of the actuators 14 and therefore the propellers 16, so that the unmanned flying object 10 rises. The control furthermore includes an assistance circuit (not shown), the function of which is explained with FIG. 2.

FIG. 2 shows an example embodiment of the control 12 as a schematic block diagram according to an embodiment of the present disclosure. The control 12 receives control commands 26, e.g., from a remote control of a user, via an antenna 22 and a receiver 24. The control commands 26 are fed to an assistance circuit 28. Sensor signals 32 received from sensors 30 are furthermore fed to the assistance circuit 28 by means of a sensor interface 33 of the control 12.

Depending on a configuration and on the sensor signals 32, the assistance circuit 28 modifies the received control commands 26 and transmits them as modified control commands 34. The modified control commands 34 are fed via a control output 35 of the control 12 to a converter 36 which is a motor control or drive. The converter 36 converts the modified control commands 34 into control signals 38. The control signals 38 serve to drive actuators 14.

The assistance circuit 28 accordingly has a configuration for converting the control commands 26. Here, the configuration includes a plurality of configuration modules which in each case contain e.g., tables or functions. The tables or functions include the control commands 26 as an input value and the converted control commands 34 as an output value. Values of the sensor signals 32 are similarly taken into account in the present example as a further variable of the configuration modules of the assistance circuit 28 represented e.g., as tables or functions.

The received control command 26 is modified accordingly with the assistance circuit 28 into modified control commands 34 depending on the configuration and on the sensor signal 32 or its values. Different modified control commands 34 therefore result from the same control command 26 depending on the current configuration.

The control 12 furthermore includes a memory 40 with a non-overwritable memory module 41 and an overwritable memory module 42. Different configuration modules for the configuration which represent the basic functions for a configuration and are therefore not intended to be modified by a user are stored in the non-overwritable memory module 41. Configuration modules generated by a user for specific applications are stored in the overwritable memory 42 and can be modified or erased at any time by a user.

The memory 40 is connected by means of a data connection 44 to an interface 43 of the assistance circuit 28, and includes a plurality of configuration modules for the configuration of the assistance circuit 28. Different configuration modules for the configuration can thus be specified for the assistance circuit 28 via the data connection 44 between the memory 40 and the assistance circuit 28. In the present example, a configuration which is intended to be used by the assistance circuit 28 is loaded from the memory 40 into the assistance circuit 28. Similarly, a memory (not shown) is accordingly present in the assistance circuit in order to store selected configuration modules previously loaded from the memory 40 therein, and to use said configuration modules as the current configuration of the assistance circuit.

The configuration presently loaded in the assistance circuit 28 is accordingly also referred to as the current configuration. However, it is also alternatively possible, according to one embodiment, for the assistance circuit 28 to access memory areas in the memory 40 which contain the configuration modules of a selected configuration via the data connection 44 depending on a selected configuration. Accordingly, the current configuration is therefore not loaded into the assistance circuit, but instead the assistance circuit 28 makes use of the current configuration in the memory 40.

The memory 40 is furthermore connected to a connection 45 for a reading device or a computer for reading data from memory cards or from the computer in order to load new configuration modules into the memory 40.

Selection means 46 are provided to control the loading or selection of the current configuration of the assistance circuit 28. The selection means 46 serve to define the configuration modules of a current configuration which is intended to be used by the assistance circuit 28.

For this purpose, the selection means 46 are similarly connected to the antenna 22 and to the receiver 24 so that selection commands 47, which are transmitted by a user with the remote control, can be received by the control 12 and can be fed to the selection means 46. A current configuration for the assistance circuit 28 is then selected with the selection means 46 according to the received selection command. An automatic circuit is furthermore provided to select configuration modules automatically also with the selection means.

In one embodiment, the control 12 furthermore includes a test circuit 48. The test circuit 48 serves to check the configuration of the assistance circuit 28 and to recognize configuration modules which would induce control commands 26 into modified control commands 34 in a conflicting manner. A message is then transmitted by the control 12 if conflicting configuration modules of this type are selected as the current configuration for the assistance circuit 28.

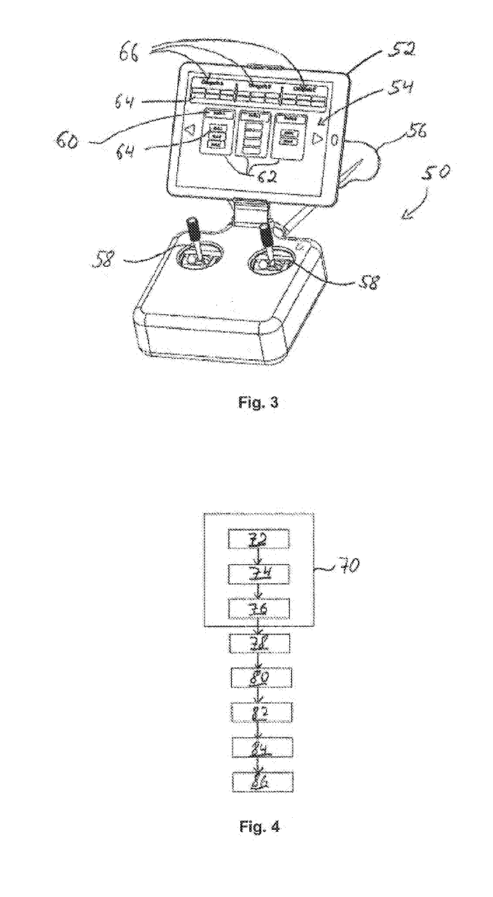

FIG. 3 shows a remote control 50 with which control commands 26 and selection commands 47 can be generated and transmitted to the control 12 according to an embodiment of the present disclosure. The remote control 50 has a screen 52 which here includes a touch-sensitive display 54 and corresponds to a tablet PC. The tablet PC is connected via a cable connection 56 to the further part of the remote control 50. The remote control 50 includes input means 58, 60 which include, on the one hand, joysticks 58 to generate control commands and, on the other hand, graphically represented fast selection keys 60 on the touch-sensitive display 54.

Selection commands 47, for example, can be generated with the graphically represented keys 60 which are fast selection keys here. A plurality of profiles 62, for example, in each case including different groups of configuration modules 64 are represented on the touch-sensitive screen. Through a touch on a key 60 of a profile 62, the configuration modules contained therein are transmitted as a selection command 47 to the selection means 46 of the control 12. The control then initiates a reconfiguration of the assistance circuit 28 so that the latter takes over the configuration modules selected with the key 60 as the current configuration. For this purpose, the selected configuration modules are loaded, for example, from the memory 40 or, in the case where they are stored in the remote control 50, from the remote control 50 into the assistance circuit 28.

A user can furthermore create his own profiles with the touch-sensitive screen by selecting configuration modules 64, which are stored in the memory 40 and are sorted into different categories 66, and by combining them to form a profile 62.

The remote control 50 shown in FIG. 3 furthermore serves to generate configuration modules by performing and recording predefined flying maneuvers directly by means of the joysticks 58 and by then storing the flying maneuver as a configuration module in the remote control 50 or in the memory 40 of the control 12. In the case where these configuration modules 64 are stored in the remote control 50, they can be transmitted to the control 12 at a later time also.

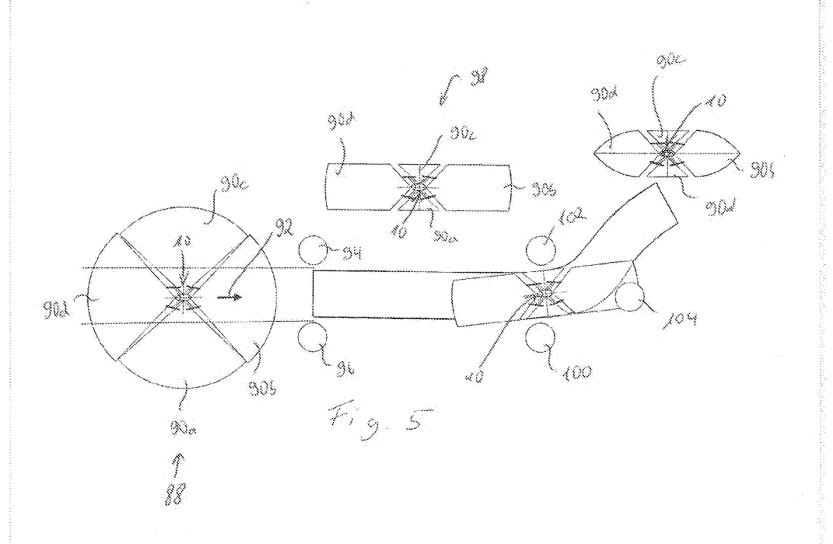

FIG. 4 shows the basic steps of a method for controlling an unmanned flying object 10, in particular with an example embodiment of the control 12 according to an embodiment of the present disclosure. Here, the assistance circuit 28 is reconfigured in block 70. In block 70, one or more configuration modules 64 are selected in block 72 by a user with a remote control 50 for the reconfiguration and selection commands 47 corresponding to the selected configuration modules; and are transmitted in block 74 to selection means 46 of the control. In block 76, the selection means 46 then loads the selected configuration modules 64 into the assistance circuit 28 as the current configuration.

Control commands are then generated in block 78 by a user with the remote control 50, are transmitted in block 80 to the control 12, and are received in block 82 by the control 12. The received control commands 26 are modified in block 84 with an assistance circuit 28 of the control 12 depending on a configuration of the assistance circuit 28, and the modified control commands 34 are transmitted in block 86 by the control 12 in order to drive actuators 14.

FIG. 5 shows the unmanned flying object 10 which has four environment sensors (not shown) according to an embodiment of the present disclosure. At a first position 88, the flying object 10 is switched to a mode for learning a new configuration module by means of a test flight. For this purpose, a basic configuration module is loaded as the configuration in which the areas 90a to 90d which are monitored by the four sensors (not shown) indicate distances which the flying object 10 should maintain from obstacles.

The flying object 10 is then steered in the direction 92 through the gap between two obstacles 94 and 96. Once the flying object 10 has flown through between the obstacles 94, 96, it assumes that the distance from the obstacles 94, 96 predefined by the flight will also be sufficient in future in the event of a flight of this type between the obstacles 94, 96 or past the obstacles 94, 96, and, therefore, adapts the areas 90a to 90d monitored by the distance sensors according to the representation at position 98.

The flying object 10 then flies through the obstacles 100, 102, 104, wherein the areas 90a to 90d are in turn adapted as a result according to the representation at position 106. These areas 90a to 90d are then stored as a configuration module and can subsequently be loaded directly as a configuration into the assistance circuit 28.

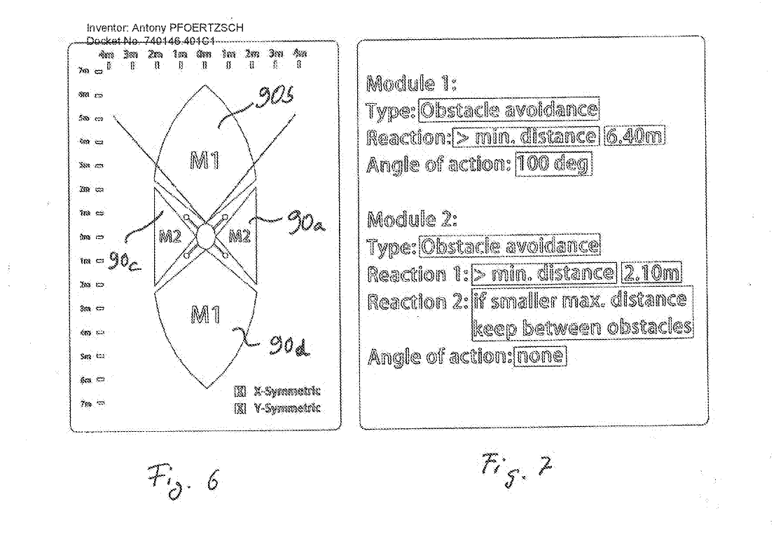

FIG. 6 now shows the areas 90a to 90d resulting from the test flight according to FIG. 5 on the screen 54 of the remote control 50 according to an embodiment of the present disclosure. The areas 90a to 90d or further parameters of the configuration module can be adapted here with by the user, in particular by means of a graphical user interface.

FIG. 7 shows a further representation on the screen 54 of the remote control 50 by means of which further parameters can be adapted directly through numeric inputs according to an embodiment of the present disclosure.

1. A control for an unmanned flying object, comprising:
a receiver configured to receive control commands to control the unmanned flying object; and
an assistance circuit configured to modify the received control commands depending on a configuration of the assistance circuit, and to transmit the modified control commands, the assistance circuit including an interface, the configuration of the assistance circuit being reconfigurable by a user with the interface.

2. The control of claim 1, further comprising:
a memory storing a plurality of configuration modules for configuring the assistance circuit; and
an interface configured to download additional configuration modules.

3. The control of claim 2, further comprising:
a selector configured to select one or more of the plurality of configuration modules, and load the selected one or more of the plurality of configuration modules from the memory in to the assistance circuit as a current configuration.

4. The control of claim 2 wherein the memory includes a memory area that is protectable by access rights or non-erasable, and a rewritable memory area, and wherein configuration modules generated by the user are storable in the rewritable memory area.

5. The control of claim 1, further comprising:
a sensor interface configured to receive sensor signals from at least one sensor that detects a surrounding environment, the assistance circuit configured to modify the received control commands depending on a current configuration of the assistance circuit and the received sensor signals.

6. The control of claim 1, further comprising:
an actuator; and
a control output configured to transmit the modified control commands to the actuator.

7. The control of claim 5, further comprising:
a memory storing a plurality of correction modules; and
an automatic selector configured to automatically select one of the plurality of correction modules for a current configuration of the assistance circuit depending on the received sensor signals.

8. A system, comprising:
a controller including:
a receiver configured to receive control commands to control an unmanned flying object, and a selection command to select a configuration module; and
an assistance circuit configured to modify the control commands based on the configuration module; and
a remote control configured to transmit the selection command to the control.

9. The system of claim 8 wherein the remote control includes:
a user interface; and
a screen configured to display a plurality of combinations of different configuration modules as groups in profiles or individual configuration modules, the plurality of combinations of different configuration modules and the individual configuration modules being selectable with the user interface, the remote control configured to generate the selection command based on configuration modules selected with the user interface.

10. The system of claim 9 wherein the remote control is configured to generate configuration modules based on flight paths that are flown and recorded, or flight paths that are graphically predefined by the user on the screen using the user interface.

11. The system of claim 8 wherein the remote control is configured to generate and transmit configuration modules to the control.

12. A method for controlling an unmanned flying object, comprising:
receiving, by a control for the unmanned flying object, control commands to control the unmanned flying object;
modifying, by an assistance circuit of the control, the control commands depending on a configuration of the assistance circuit; and
transmitting, by the control, the modified control commands.

13. The method of claim 12, further comprising:
receiving, by the control, sensor signals from at least one sensor that detects a surrounding environment; and
modifying, by the assistance circuit, the received control commands depending on a current configuration of the assistance circuit and the received sensor signals.

14. The method of claim 12, further comprising:
recording control commands and sensor data of sensors during a flight path of the unmanned the flying object; and
converting the recorded commands and sensor data in to one or more configuration modules.

15. The method of claim 14, further comprising:
selecting, via a user interface of the remote control, one or more configuration modules stored in the remote control;
transmitting, by the remote control, the selected one or more configuration modules to the control; and
storing, by the control, the selected one or more configuration modules in a memory.

16. The method of claim 15 wherein the user interface includes fast selection keys that are configured to select individual configuration modules or groups of configuration modules.

17. The method of claim 15, further comprising:
subsequent to a system start of the unmanned flying object or the remote control, comparing the selected one or more configuration modules and a current configuration of the assistance circuit; and
generating a fault signal in the event of existing conflicting characteristics between the selected one or more configuration modules and the current configuration of the assistance circuit.

18. The method of claim 12, further comprising:
reconfiguring the configuration of the assistance circuit by a user or automatically.

19. The method of claim 12, further comprising:
driving actuators using the modified control commands.
